(19) United States
(12) Patent Application Publication
(10) Pub. No.: US 2004/0039884 A1
(43) Pub. Date: Feb. 26, 2004

(54) System and method for managing the memory in a computer system

(76) Inventor: Qing Li, San Jose, CA (US)

Correspondence Address: Fay Kaplun & Marcin, LLP, Suite 702, 150 Broadway, New York, NY, 10038, US

(21) Appl. No.: 10/226,493

(22) Filed: Aug. 21, 2002

(51) Int. Cl. G06F 12/00

(52) U.S. Cl. 711/156; 711/150; 711/151; 711/158

(57) ABSTRACT

A system, comprising a memory block for storing data associated with a task, the memory block being included in a memory pool, and status information including memory block information, wherein the task accesses the memory block by acquiring a semaphore and a mutex corresponding to the memory pool, the task updating the memory block information of the status information to indicate the task is accessing the memory block.

### BACKGROUND INFORMATION

A computing device system is comprised of numerous different components, each of which has a particular function in the operation of the computer system. Examples of computing devices include personal computers (“PCs”), personal digital assistants (“PDAs”), embedded devices, etc. FIG. 1 depicts an exemplary embodiment of a PC 1 which may be a computing device or other microprocessor-based device including a processor 10, system memory 15, a hard drive 20, a disk drive 25, I/O devices 30, a display device 35, a keyboard 40, a mouse 45 and a connection to communication network 50 (e.g., the Internet). Each of these components in the PC 1 has one or more functions which allow the PC 1 to operate in the manner intended by the user. For example, a hard drive 20 stores data and files that the user may wish to access while operating the PC 1, the disk drive 25 may allow the user to load additional data into the PC 1, I/O devices 30 may include a video card which allows output from the PC 1 to be displayed on the CRT display device 35.

Other computing devices may have more or less components as described above for the PC 1. However, every computing device has some type of system memory 15, for example, Random Access Memory (“RAM”) which is a type of memory for storage of data on a temporary basis. In contrast to the memory in the hard drive 20, system memory 15 is short term memory which is essentially erased each time the PC 1 is powered off. System memory 15 holds temporary instructions and data needed to complete certain tasks. This temporary holding of data allows the processor 10 to access instructions and data stored in system memory 15 very quickly. If the processor 10 were required to access the hard drive 20 or disk drive 25 each time it needed an instruction or data, it would significantly slow down the operation of the PC 1. All the software currently running on the PC 1 require some portion of system memory 15 for proper operation. For example, the operating system, currently running application programs and networking software may all require some portion of the memory space in system memory 15. Using the example of an application program, when the user of the PC 1 enters a command in the keyboard 40 or mouse 45 to open a word processing program, this command is carried out by the processor 10. Part of executing this command is for data and instructions stored in the hard drive 20 for the word processing program to be loaded into system memory 15 which can provide data and instructions to the processor 10 more quickly than the hard drive 20 as the user continues to enter commands for the word processing program to execute. When system memory 15 is RAM, the memory is allocated to the applications as needed.

In today's computing environments, a computing device may have a processor that can simultaneously run multiple tasks or multiple processors running multiple tasks. Each of these tasks may need access to the system memory. Current memory management systems have problems with multitasking such as priority inversions where a lower priority task is using the system memory while a higher priority task is waiting for the system memory. Thus, an efficient manner of allocating the system memory to different tasks is needed.

### SUMMARY OF THE INVENTION

A system, comprising a memory block for storing data associated with a task, the memory block being included in a memory pool, and status information including memory block information, wherein the task accesses the memory block by acquiring a semaphore and a mutex corresponding to the memory pool, the task updating the memory block information of the status information to indicate the task is accessing the memory block.

A method, comprising the steps of acquiring a semaphore corresponding to a memory pool having memory blocks, wherein a value of the semaphore is equal to a number of free memory blocks in the memory pool, acquiring a mutex corresponding to the memory pool, and accessing one of the free memory blocks.

Furthermore, a system, comprising a semaphore corresponding to a memory pool, the memory pool including memory blocks, a value of the semaphore being equal to a number of free memory blocks in the memory pool, wherein a task attempting to access the free memory blocks acquires the semaphore, the value being decremented by one when the task acquires the semaphore, and a mutex corresponding to the memory pool, wherein the task acquires the mutex allowing the task to access one of the free memory blocks.

### BRIEF DESCRIPTION OF DRAWINGS

FIG. 1 depicts a conventional computing device;

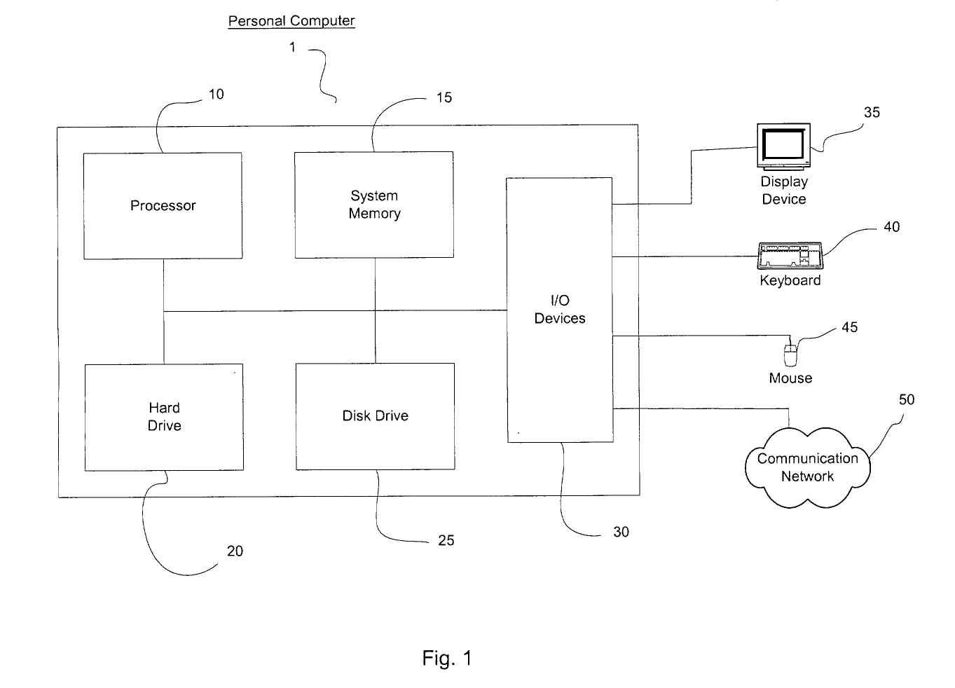

FIG. 2 shows an exemplary memory management system according to the present invention;

FIG. 3a shows an exemplary process for gaining access to a memory block according to the present invention;

FIG. 3b shows an exemplary process for releasing a memory block according to the present invention;

FIG. 4 shows multiple tasks attempting to access system memory using the exemplary memory management system according to the present invention;

FIG. 5 shows an exemplary process whereby a higher priority task may gain faster access to a memory pool semaphore according to the present invention.

### DETAILED DESCRIPTION

The present invention may be further understood with reference to the following description and the appended drawings, wherein like elements are provided with the same reference numerals. Throughout this specification the term system memory will be used, and it should be understood that this term may refer to any type of RAM, for example, Static RAM (“SRAM”), Dynamic RAM (“DRAM”), Synchronous DRAM (“SDRAM”), Enhanced DRAM (“EDRAM”), etc, but also to any type of temporary memory device that stores data and/or instructions for use by a computing device. Additionally, throughout this specification, the system memory will be discussed as being accessed and allocated by a processor or microprocessor and it should be understood that the present invention may be implemented in any computing and/or electronic device where processors and/or microprocessors perform such functions, for example, PCs, servers, internet devices, embedded devices, or any computing device and the term device will be used to generally describe such devices. The exemplary memory management system of the present invention may be used for any type of device (or system), but may be particularly useful for real-time embedded systems.

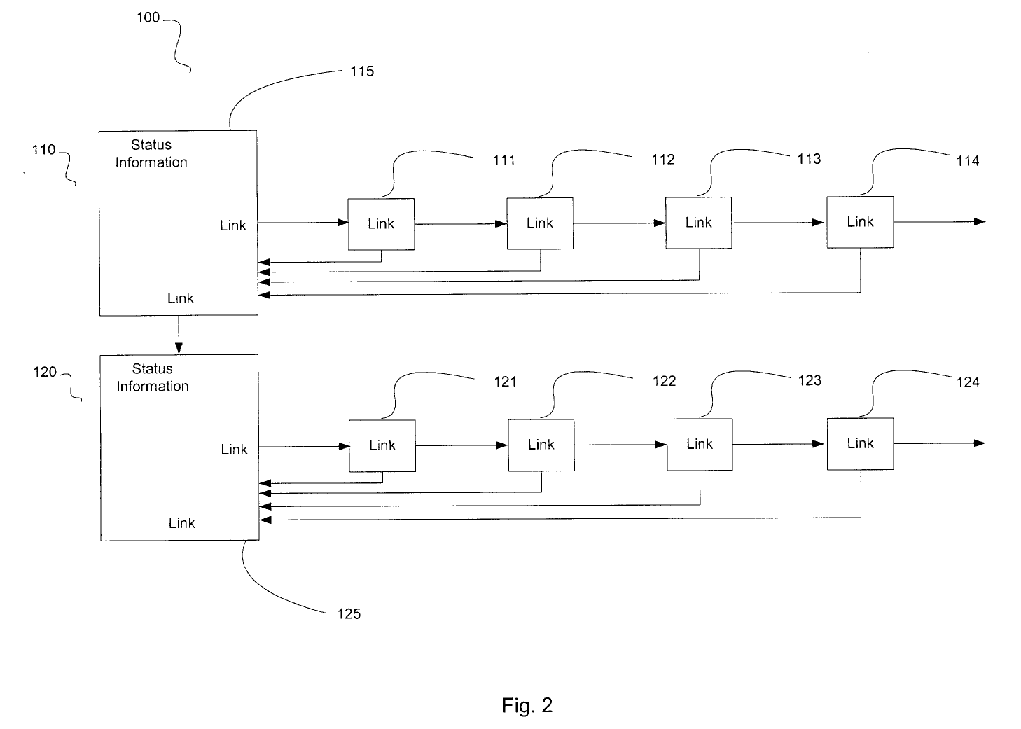

FIG. 2 shows an exemplary memory management system 100 including a plurality of memory pools 110-120, each of which has a series of memory blocks 111-114 and 121-124. The memory blocks 111-114 and 121-124 are chunks or pieces of the system memory (e.g., RAM). Each memory block in any specific memory pool is the same size as the other memory blocks in the same pool. For example, the memory pool 110 may be the memory pool for 64-byte memory blocks, meaning that each of the memory blocks 111-114 is 64-bytes long. The memory pool 120 may be the memory pool for 128-byte memory blocks, meaning that each of the memory blocks 121-124 is 128-bytes long. Those of skill in the art will understand that the use of two memory pools having four memory blocks in the exemplary memory management system 100 is only exemplary. A memory management system according to the present invention may implement any number of memory pools including any number of memory blocks. In addition, the 64-byte and 128-byte memory block length is only exemplary, the device may be initialized with memory pools having any length memory blocks.

Each of the memory pools 110-120 may also include status information 115 and 125, respectively. The status information 115-125 may contain various types of information about the individual memory pool. The information may include, for example, pointers to the linked list of memory blocks, the size of the memory blocks, the locations of the memory blocks, the number of available memory blocks, the total number of memory blocks allocated during creation time, the total number of missed allocations, etc. As can be seen in FIG. 2, each memory block has a back pointer to the status information for its memory pool, e.g., each of memory blocks 111-114 has a back pointer to the status information 115 for the memory pool 110. This back pointer may be used to de-allocate memory blocks, a process for which is described in greater detail below.

A mutex and a semaphore may be associated with each of the memory pools 110-120. A semaphore is a technique for coordinating or synchronizing activities in which multiple tasks compete for the same system resources (e.g., system memory). A semaphore is a synchronization primitive provided by the underlying kernel. Each semaphore is initialized with a counter value equaling the total number of memory blocks created for the memory pool. A task that requires a memory block will try to acquire the semaphore first. A successful acquisition of the semaphore implies the task has successfully reserved one block of memory from the available blocks for its use, but the task has yet to obtain the actual memory block. An unsuccessful acquisition implies the memory pool is depleted. The kernel will decrement the counter value associated with the semaphore by one for a successful acquisition. In the exemplary embodiment of the present invention, each memory pool 110-120 includes a semaphore. Thus, the memory pool 110 has a first semaphore and the memory pool 120 has a second unique semaphore.

A mutex (mutual exclusion object) is another synchronization primitive provided by the underlying kernel. In an environment where multiple tasks (or threads) execute concurrently and compete to access a shared resource, a mutex is used to ensure the exclusive access by a single task to the shared resource for the duration of time between that task's acquisition and release of the mutex. When the memory management system 100 is initiated, a unique mutex may be created for each memory pool 110-120. The mutex for each memory pool 110-120 may have a unique name or ID. After that, any task needing the resource must use the mutex to lock the resource from other tasks while it is using the resource. The use of the mutex and semaphore for the memory pools rather than interrupt locks minimizes the impact of the memory management system 100 on the overall running system, for example, it avoids the missing of interrupts and priority inversion problems. A more detailed description of the use of the mutex and semaphore for each memory pool will be given below.

When an application (or task) needs a certain amount of system memory, the memory management system 100 allocates the required amount of system memory to the application. For example, if a task needed 128 bytes of system memory, the memory management system 100 may allocate one of the memory blocks 121-124 from memory pool 120. However, as described above, there may be numerous tasks attempting to gain access to the system memory and the memory management system 100 needs to control access to the system memory to ensure consistent state information for the memory pool.

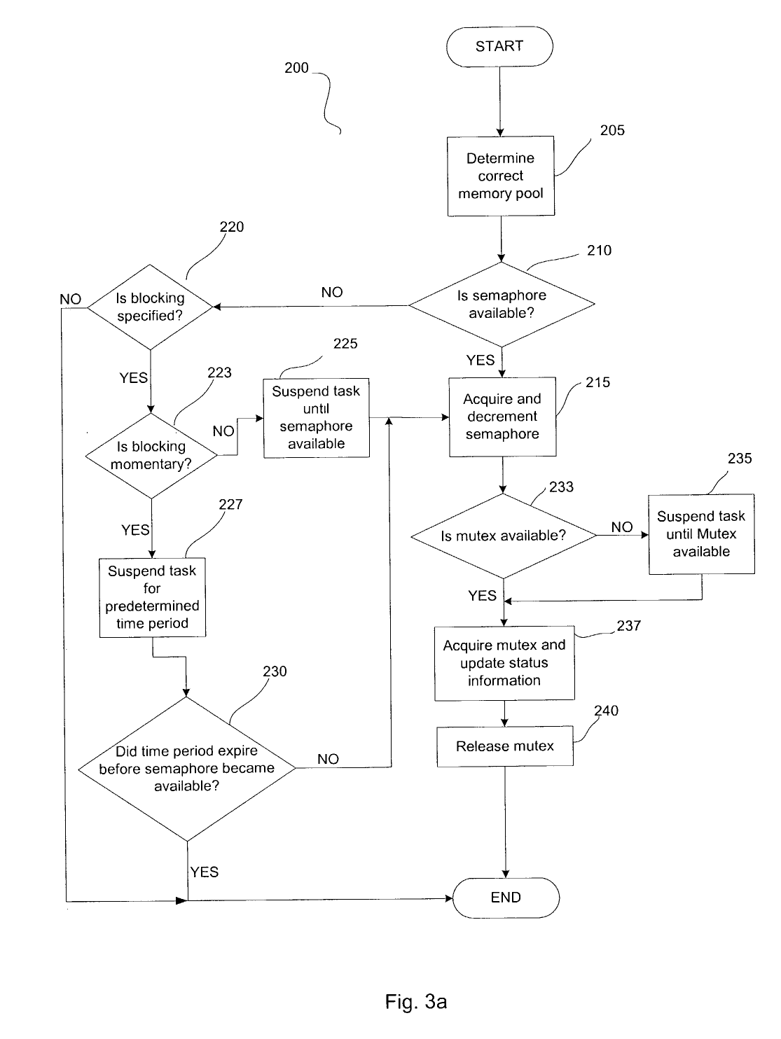

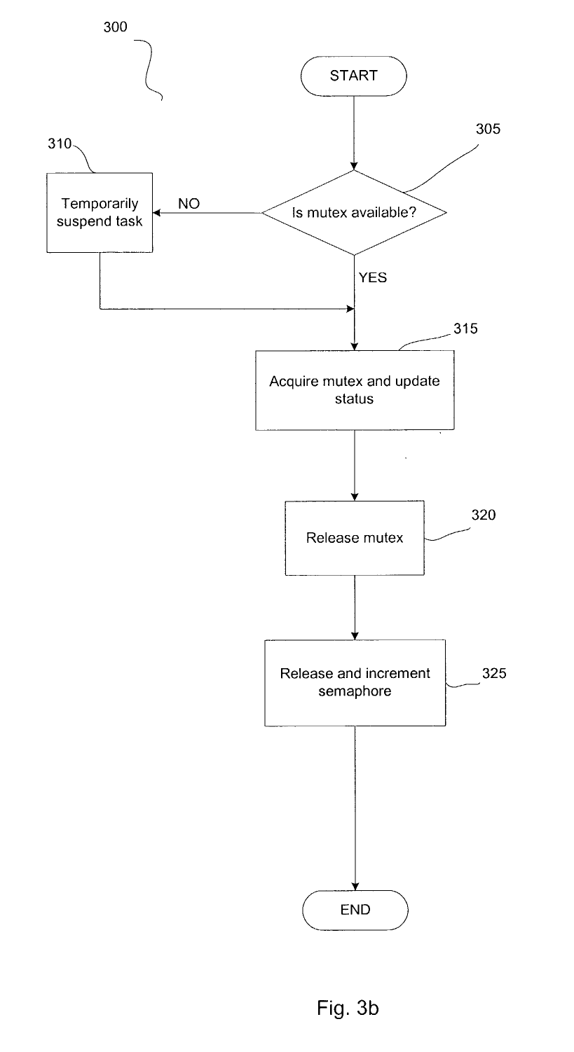

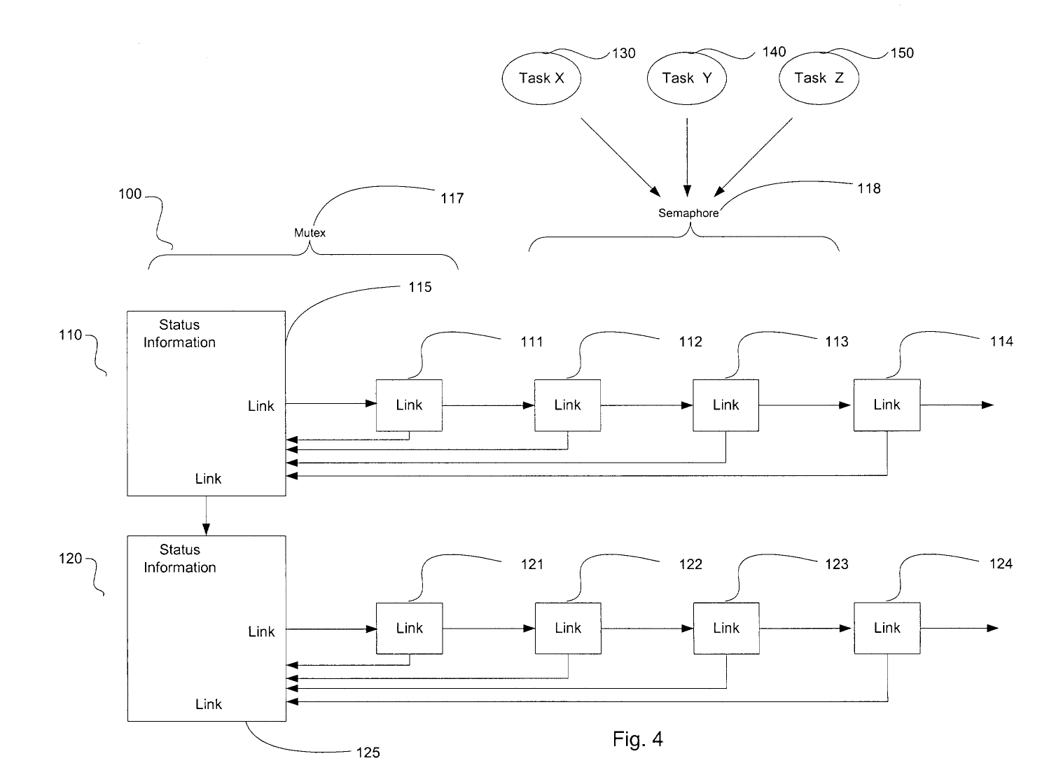

FIG. 3a shows an exemplary process 200 for a task to gain access to a memory block. The exemplary process will be described with reference to FIG. 4 which shows multiple tasks 130-150 attempting to access system memory using the exemplary memory management system 100. In step 205, the memory manager 100 determines which memory pool should be accessed based on the amount of memory space needed by the task. For example, if the task 130 needed 64-bytes of memory space, the task 130 may determine that it needs a 64-byte memory block and therefore needs a memory block from the memory pool 110 (e.g., the 64-byte memory pool).

The process then continues to step 210 where it is determined whether the semaphore for that memory pool is available. As described above, each memory pool has a unique semaphore with an associated value. For example, when the memory management system 100 is initiated, the semaphore for each memory pool may be initiated to a value that equals the number of memory blocks in that memory pool. Thus, if it were considered that the semaphore 118 was associated with the memory pool 110, upon initialization of the memory management system 100, the semaphore 118 may have a value of four which is equal to the exemplary number of memory blocks 111-114 in the memory pool 110. As will be described in greater detail below, a task may acquire a semaphore. Part of the acquisition of the semaphore includes decrementing the semaphore value. For example, if the semaphore 118 was acquired by a task, the value of the semaphore would be decremented from four to three. As will become apparent below, the value of the semaphore for any memory pool will be equal to the number of free memory blocks available in that memory pool. Those of skill in the art will understand that if the semaphore is maintained by the underlying kernel, the decrementing of the semaphore value (and all other semaphore related activities) will be performed by the semaphore functions and/or primitives of the kernel, for example, by the task accessing the kernel primitives and/or functions.

In step 210, the process of determining whether the semaphore is available is determined based on the value of the semaphore. If the semaphore has a value of zero (0), that means that there are no free memory blocks available in the memory pool and the task may not acquire the semaphore. If the semaphore has a non-zero value, there are free memory blocks available in the memory pool and the task may acquire the semaphore.

Continuing with the example from above where the task 130 needs a 64-byte memory block 111-114 from the memory pool 110. The task 130 will look at the value of the semaphore 118 for memory pool 110. If the semaphore 118 value is non-zero (e.g., three), the task 130 may then proceed to step 215 where the task 130 acquires the semaphore 118 and decrements the semaphore 118 value, e.g., from three to two. As described above, the exemplary semaphore 118 value of three indicates that there are three free memory blocks in memory pool 110, i.e., three of memory blocks 111-114 are available and one is unavailable. The one memory block may be unavailable because any one of the tasks 130-150 may have previously acquired the now unavailable memory block. When the task 130 acquires the semaphore 118, it becomes the owner of one of the free memory blocks 111-114 in the memory pool 110. This step does not assign any one of the memory blocks 111-114 to the task 130, but reserves one of the memory blocks 111-114 for the task 130. The actual assignment of the memory block to the task is described on greater detail below.

In addition, the decrementing of the semaphore 118 value, indicates to the other tasks 140-150 (or the same task 130) that the memory pool 110 has one less free memory block 111-114 because one free memory block 111-114 has been assigned to task 130. Thus, when the next task (e.g., the task 140) needing a memory block 111-114 from the memory pool 110 looks at the semaphore 118 value, it will see the decremented value of two rather than three.

If it is determined that the semaphore 118 value is zero (0) in step 210, the task 130 cannot acquire the semaphore 118 and the process continues to step 220. A semaphore 118 value of zero (0) indicates that the memory pool is depleted, i.e., there are no available memory blocks in the memory pool. When this occurs, the exemplary embodiment of the present invention may include a memory allocation wait scheme. The wait scheme may be referred to as a blocking scheme. The task making the memory request specifies the blocking scheme. In step 220, it is determined whether a blocking scheme including a wait period has been specified. If the task did not specify a waiting blocking scheme (e.g., non-blocking memory allocation), the task 130 would immediately cease attempts to acquire the semaphore 118 and the process would end. If the task incorporated a waiting blocking scheme, the process would continue to step 223 where it is determined if the blocking is momentary. If the blocking scheme was not momentary (e.g., blocking memory allocation), the task 130 would be suspended until the semaphore 118 was available (step 225). The process would then proceed to step 215 where the task could acquire the semaphore.

If it is determined in step 223 that the task specified a momentary blocking memory allocation, the task 130 would be suspended for a predetermined period of time for the semaphore 118 to become available. The predetermined period of time may be specified by the task 130. For example, when the task 130 cannot immediately acquire the semaphore 118, the task 130 may determine that it has five minutes remaining to complete the operation on schedule. The task 130 may then determine that it can wait four minutes to acquire the semaphore 118 and still complete the task on schedule. In this case, the task 130 may be suspended for four minutes in step 227. In step 230, it would be determined whether the semaphore 118 became available during the predetermined time period. If the four minute time period expired without the semaphore 118 becoming available, the process 200 would end. If the semaphore became available within the four minute timer period, the process would continue to step 215 where the task 130 could acquire the semaphore 118.

A blocking scheme that allows the task to wait may be useful in network arrangements that have burst type traffic patterns, e.g., real-time networks. For example, in real-time networks the traffic pattern may be such that an enormous amount of network traffic occurs at the same time causing congestion, but the traffic clears in a relatively short amount of time. During the congestion period, there may be a memory exhaustion condition, i.e., all the memory blocks of various memory pools are being used. If the memory management system 100 implements a non-blocking scheme during this congestion period, various multi-threaded tasks may not be able to acquire memory blocks and will fail. However, if one of the above described blocking schemes is implemented, the various tasks may not fail, but just temporarily suspend their operations until a memory block is available. In this manner, multiple threads of tasks may be completed without failure.

In addition, the exemplary embodiment of the present invention also supports blocking at the various sockets in a device. A socket serves is an application endpoint for exchanging data between various tasks on the same device, or between tasks on different devices. For example, as a data packet is being passed up the protocol stack in the device, it may be blocked within the protocol stack if no memory block is available for the stack to do the processing of the data packet. However, the blocking will only be temporary until a memory block is available and the processing of the data packet will not fail completely. Thus, the various threads may share the system resources to process the data in the most efficient manner.

Continuing with step 233 of the process 200, the task may then determine whether the mutex is available. As described above, the mutex allows only a single task to gain access to the memory pool at any particular time. For example, each of the tasks 130-150 may have acquired the semaphore 118 for memory pool 110 which guarantees each of the tasks one of the memory blocks 111-114. However, each of the tasks 130-150 cannot simultaneously access the status information 115 for the memory pool 110. The mutex 117 that is associated with memory pool 110 allows only one of the tasks 130-150 to access memory pool 110 at any particular time.

As shown in FIG. 4 and previously described above, the status information 115 contains various information about the memory pool 110 and its memory blocks 111-114. If multiple tasks were allowed access to the status information 115 at the same time, it is possible that the different tasks may change the status information 115 in ways that are inconsistent with the changes being made by the other tasks, e.g., incorrect pointers to the linked list, location of blocks, etc. The mutex ensures that only one task at a time may access and update the status information for a particular memory pool, resulting in synchronized status information.

If in step 233 the mutex is not available, the process continues to step 235 where the task is temporarily suspended until the mutex becomes available. If the mutex is not available in step 233, this means that another task is currently holding the mutex. For example, if task 130 is attempting to acquire the mutex 117 to gain access to memory pool 110 and the mutex 117 is not available, it may be because one of tasks 140 or 150 that has acquired the semaphore 118 for memory pool 110 has already acquired mutex 117 and is updating the status information 115 for the memory pool 110.

If in step 233 the mutex is available or if the mutex becomes available after the task is temporarily suspended in step 235, the process continues to step 237 where the task acquires the mutex and the memory block and the task is run by the processor. Continuing with the example of task 130 attempting to acquire mutex 117 when it becomes available, the task 130 acquires the mutex 117 and, thus, the mutex 117 is not available for any other task. The task 130 may now access the status information 115 for the memory pool 115 in order to gain access to the actual memory block which the task 130 will use. For example, the status information 115 for the memory pool 110 may indicate that the memory block 113 is the next available memory block. The task 130 may then update the status information 115 to indicate that it is going to access and use memory block 113 when the task 130 is run by the processor, e.g., update the linked list of memory blocks in status information 115.

The task 130 is ready for processing because it has now acquired the memory block (e.g., memory block 113). Those of skill in the art will understand that the task 130 may not be processed immediately because the operating system generally has a scheduler which allots processor time based on the priority of the task. The task 130, because it has acquired the needed memory block for processing, is ready to be placed into the queue of the scheduler to be allotted processor time based on its priority. The task priority and the effect of the exemplary embodiment of the present invention on task priority will be discussed in more detail below.

When the task 130 has updated the status information 115 and obtained the necessary memory block 113, it may release the mutex 117 so that other tasks that have acquired the semaphore 118 may acquire the mutex 117 (step 240). After step 240 is completed the process 200 for acquiring a memory block is completed.

FIG. 3b shows an exemplary process 300 for releasing a memory block after the task is executed by the processor. Continuing with the example from above, when the task 130 is executed, the task 130 may release the memory block (e.g., memory block 113). In order to release the memory block, the task 130 needs to once again acquire the mutex 117 so it has access to the status information 115. In step 305, the process determines whether the mutex 117 is available. If the mutex is not available, the process continues to step 310 where the task is temporarily suspended until the mutex 117 becomes available. Once again, the reason the mutex 117 is not available is because another task which acquired the semaphore 118 may have acquired the mutex 117 (e.g., the task 150).

If in step 305 the mutex 117 is available or when the mutex 117 becomes available while the task 130 is temporarily suspended in step 310, the process continues to step 315 where the task 130 acquires the mutex 117. The task 130 may then release the memory block and update the status information 115 to reflect that the memory block is no longer allocated to the task 130. As described above, each memory block may have a back pointer to the status information, e.g., the memory block 113 may have a back pointer to the status information 115, which may be used during this de-allocation process. After the status information is updated, the process may continue to step 320 where the task 130 may release the mutex 117 so that other tasks that have acquired the semaphore 118 may acquire the mutex 117. After the mutex is released, the task may continue to step 325 where the semaphore is also released so that it is available to other tasks. When the semaphore is released, the semaphore value is incremented to reflect that the memory block released by the task is available for other tasks. The process is then complete.

Those of skill in the art will understand that there are alternative processes to the above described process 300 for releasing a memory block. For example, after the status information is updated upon the release of the memory block, the task may release the semaphore prior to releasing the mutex. In this manner the semaphore value may be incremented and the semaphore may become available sooner for any tasks that are suspended awaiting the semaphore to become available.

As described above, the exemplary memory management system 100 may implement various blocking schemes, e.g., blocking memory allocation, momentary blocking memory allocation, non-blocking memory allocation. A feature of the exemplary embodiment of the memory management system 100 implementing a blocking scheme where a task may wait for an available semaphore rather than failing is that the memory management system may work in conjunction with the processor scheduling algorithm to avoid priority inversions. For example, referring to FIG. 4, the semaphore 118 for memory pool 110 may have a value of zero (0) indicating that there are no free memory blocks in memory pool 110. Each of the tasks that have acquired the semaphore 118 may have a low priority level. The task 130, which in this example is a high priority level task, may be attempting to acquire the semaphore 118, but it is not available because other tasks which are lower priority have previously acquired the semaphore 118. If the memory management system 100 employs a blocking scheme where the task 130 will wait for the semaphore 118 to become available, the memory management system 100 may be able to facilitate the faster availability of the semaphore 118 for the task 130.

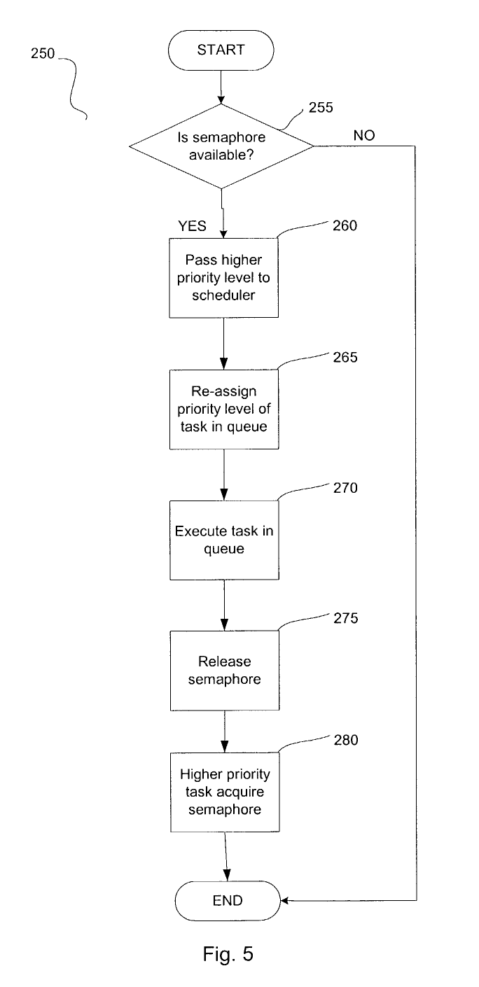

FIG. 5 shows an exemplary process 250 whereby a higher priority task may gain faster access to a memory pool semaphore. In step 255 it is determined whether a higher priority task is waiting for a semaphore that has been previously acquired by a lower priority task. As described above, the semaphore may be implemented by the underlying kernel which contains (or makes available) a set of primitives (or functions) allowing access to the semaphore. The task when calling the primitive may pass the primitive information concerning the task (e.g., task identification, task priority, etc.) In this manner, the kernel knows the priority of the task that is attempting to acquire the semaphore and the priority of the tasks which, through previous primitive calls, have acquired the semaphore. Thus, it may be determined in step 255 whether a higher priority task is waiting for a semaphore that has been previously acquired by a lower priority task.

If the task that is blocked is not a higher priority than those that have already acquired the semaphore, the process ends. If the task that is blocked is a higher priority than those that have already acquired the semaphore, the process continues to step 260 where the the higher priority level of the waiting task is passed to the scheduling algorithm. Continuing with the above example, the priority level of the higher priority task (e.g., task 130) is thus passed to the scheduling algorithm. In step 265, the priority level of the lower priority task that is in the scheduling queue is overridden with the priority level of the blocked higher priority level task.

The scheduling algorithm may then move the lower priority task to a new higher priority location in the scheduling queue based on the higher priority level assigned to the task. This new priority level is only temporary and is based on the waiting higher priority task, i.e., the next time the task is run it will be at its own priority level unless the same situation of a blocked higher priority task arises. The lower priority task will then be executed based on its location in the scheduling queue (step 270). This execution with the temporarily assigned higher priority level should occur faster than if the task were to have remained at its original lower priority level. After the task has been completed, the task may then release the semaphore (step 275), for example, in accordance with the process 300 described with reference to FIG. 3b.

Once the semaphore (e.g., semaphore 118) is released in step 275, the blocked higher priority task (e.g., task 130) may acquire the semaphore in step 280. As can be seen from this exemplary process, it is possible to facilitate the faster availability of the semaphore for the higher priority task. In this manner the higher priority task may be completed because it had the ability to be blocked so that the semaphore could become available. This feature alleviates the so-called “priority inversion” problem where a higher priority task fails because a lower priority task is using the system resources which the higher priority task needs.

In contrast, had the blocking scheme been non-blocking memory allocation, the higher priority task may have failed because the semaphore was not available. Those of skill in the art will understand that there may be situations where the system administrator may determine that the non-blocking memory allocation scheme is the correct scheme for the particular system and implement that scheme.

The exemplary embodiment of the memory management system 100 is reentrant which means that it allows for simultaneous memory allocation requests from multiple tasks (or threads). For example, referring to FIG. 4, the task 130 may be accessing the memory pool 110 at the same time that task 140 is accessing the memory pool 120. As described above, the mutex prevents two tasks from simultaneously accessing the same pool, but the system does allow for multiple tasks to simultaneously access multiple memory pools.

As described above, the memory management system 100 having two memory pools 110 and 120, each of which has four memory blocks 111-114 and 121-124 is only exemplary. A memory management system according to the present invention may include any number of memory pools and each memory pool may have any number of memory blocks. Those of skill in the art will understand how the principles described above for the exemplary memory management system 100 may be extended to systems having more memory pools and/or memory blocks.

In addition, it may be possible to add memory pools and memory blocks dynamically during run-time. For example, during run-time it may be determined that the memory blocks 111-114 of the memory pool 110 are causing congestion because they are used frequently. The system may desire to add more memory blocks to the memory pool 110 to alleviate this congestion. In order to add these new memory blocks, the system must determine that there is space available for additional blocks in system memory and then allocate this system memory to the new blocks for the memory pool 110. The allocation of the new blocks to the memory pool 110 may include changing the status information 115 to include information about these new blocks. For example, the semaphore 118 may have to be re-initialized to a value that reflects the availability of the new blocks, e.g., if the value of the semaphore 118 was four reflecting the four memory blocks 111-114 as available and four additional memory blocks were added to the memory pool 110, the semaphore may be re-initialized to a value of eight reflecting the new total number of available blocks in the memory pool 110.

The process of dynamically adding a new memory pool would include the system determining if there was space available for an additional pool of memory blocks in system memory. If the space was available, the system could create a new memory pool by creating status information for the new memory pool including and the information described above for the existing memory pools. For example, if memory management system 100 decided to add a new memory pool having 256-byte memory blocks to the existing pools of 64-bytes (memory pool 110) and 128-bytes (memory pool 120), it could create new status information containing all the information for the new 256-byte memory pool, e.g., number and location of memory blocks, semaphore with value, mutex, etc. The new memory pool could then be initialized during runtime and used by the memory management system.

In the preceding specification, the present invention has been described with reference to specific exemplary embodiments thereof. It will, however, be evident that various modifications and changes may be made thereunto without departing from the broadest spirit and scope of the present invention as set forth in the claims that follow. The specification and drawings are accordingly to be regarded in an illustrative rather than restrictive sense.

What is claimed is:

1. A system, comprising:
a memory block for storing data associated with a task, the memory block being included in a memory pool; and
status information including memory block information, wherein the task accesses the memory block by acquiring a semaphore and a mutex corresponding to the memory pool, the task updating the memory block information of the status information to indicate the task is accessing the memory block.

2. The system according to claim 1, wherein the memory block is included in random access memory.

3. The system according to claim 1, wherein the memory block is a predetermined size.

4. The system according to claim 1, wherein the semaphore and the mutex are implemented by an operating system.

5. The system according to claim 1, wherein, when the semaphore is unavailable, the task is suspended until the semaphore becomes available.

6. The system according to claim 1, wherein, when the semaphore is acquired, a value of the semaphore is decremented.

7. The system according to claim 1, wherein the status information includes one of a size of the memory block and a location of the memory block.

8. The system according to claim 1, wherein the task further updates the status information to indicate the task is finished accessing the memory block and the task releases the mutex and the semaphore.

9. The system according to claim 1, further comprising:
additional memory blocks included in the memory pool, wherein the status information includes additional memory block information, an additional task acquiring the semaphore and the mutex to access one of the additional memory blocks.

10. The system according to claim 9, wherein the task and the additional task have simultaneous possession of the semaphore.

11. The system according to claim 9, wherein, when the task acquires the mutex, the mutex is unavailable for the additional task.

12. The system according to claim 9, wherein the task and the additional task are implemented via one of a single unit of execution and multiple units of execution.

13. The system according to claim 9, wherein the memory block and the additional memory blocks are a linked list of memory locations.

14. The system according to claim 9, further comprising:
further memory blocks included in a further memory pool, wherein the task accesses one of the further memory blocks by acquiring a further semaphore and a further mutex corresponding to the further memory pool; and
a further status information including memory block information for the further memory blocks, the task updating the further status information to indicate the task is accessing the one of the further memory blocks.

15. The system according to claim 14, wherein the memory block and each of the additional memory blocks are a first predetermined size and each of the further memory blocks are a second predetermined size.

16. A method, comprising the steps of:
acquiring a semaphore corresponding to a memory pool having memory blocks, wherein a value of the semaphore is equal to a number of free memory blocks in the memory pool;
acquiring a mutex corresponding to the memory pool; and
accessing one of the free memory blocks.

17. The method according to claim 16, further comprising the step of:
suspending the semaphore acquiring step when the semaphore value is equal to zero.

18. The method according to claim 17, wherein the suspension is maintained until the semaphore value is non-zero.

19. The method according to claim 17, wherein the suspension is maintained for a predetermined period of time.

20. The method according to claim 16, wherein the accessing step includes the sub-step of:
updating status information for the memory pool to indicate the one of the free memory blocks being accessed.

21. The method according to claim 16, further comprising the step of releasing the mutex.

22. The method according to claim 21, further comprising the steps of:
reacquiring the mutex; and
further updating the status information to indicate that access to the one of the free memory blocks is finished.

23. The method according to claim 22, further comprising the steps of:
releasing the mutex; and
releasing the semaphore.

24. A system, comprising:
a semaphore corresponding to a memory pool, the memory pool including memory blocks, a value of the semaphore being equal to a number of free memory blocks in the memory pool, wherein a task attempting to access the free memory blocks acquires the semaphore, the value being decremented by one when the task acquires the semaphore; and
a mutex corresponding to the memory pool, wherein the task acquires the mutex allowing the task to access one of the free memory blocks.

25. The system according to claim 24, wherein, when the task acquires the mutex, the task modifies status information of the memory pool to indicate the task is accessing the one of the free memory blocks.

26. The system according to claim 25, wherein the status information includes one of a size of the memory blocks, the number of free memory blocks, a location of each of the free memory blocks and a total number of memory blocks.

27. The system according to 24, wherein, when the semaphore value is equal to zero, the semaphore is unavailable for acquisition by the task.

28. The system according to claim 27, wherein the task waits a predetermined time period for the semaphore to become available.

29. The system according to claim 24, wherein the task and an additional task have simultaneous possession of the semaphore.

30. The system according to claim 29, wherein the task and the additional task are implemented via one of a single unit of execution and multiple units of execution.

31. The system according to claim 24, wherein, when the task releases the semaphore, the semaphore value is incremented by one.
